(19) United States
(12) Patent Application Publication
(10) Pub. No.: US 2014/0089860 A1
(43) Pub. Date: Mar. 27, 2014

(54) DIRECT MANIPULATION OF DATA DISPLAYED ON SCREEN

(71) Applicant: SAP AG, Walldorf (DE)

(72) Inventors: Timo HOYER, South San Francisco, CA (US); Sascha Hans GRUB, Saarbrucken (DE)

(73) Assignee: SAP AG, Walldorf (DE)

(21) Appl. No.: 13/625,538

(22) Filed: Sep. 24, 2012

(51) Int. Cl. G06F 3/048

(52) U.S. Cl. 715/843; 715/810

(57) ABSTRACT

A method for displaying on a computing device includes retrieving a data object including an enterprise data from a database, displaying at least one axis including at least one action element associated with the at least one axis on a screen, responsive to a user selection of the at least one action element, displaying a list of selectable attributes of the data, and responsive to selecting an attribute from the list of attributes, displaying a subset of the data reflecting the selected attribute.

### BACKGROUND

Data objects stored on enterprise database may include multi-dimensional data. Each dimension of the data may represent an attribute of the data. One or a subset of dimensions of the data may be retrieved in response to a request of the user and displayed on a screen of a computing device. For example, human resource data may be displayed as graphs with respect to selected data dimensions such as locations, gender, or talent etc. The displayed graphs may be in the forms of bar graph, pie graph, or any suitable graph forms. The display device may be a desktop terminal having a keyboard or a tablet device such as a tablet computer or a smart phone that has a touch screen rather than the keyboard.

Touch screen devices, such as a smart phones and tablets, allowed users to interact with applications on smaller portable devices without the need for an external keyboard, touchpad, or mouse. In the environment for the tablet device, the user may want to change views of the displayed graph. For example, the user may want to change between a bar graph and a pie graph of a particular display. Moreover, the user often wants to switch from displaying one aspect of the data to displaying other aspects of the data. For example, the display of a headcount report may first show the headcount in accordance with the geographic location. The display may be in the form of a bar graph in which the x-axis indicates the headcount and the y-axis indicates geographic locations Later, the user may want to switch or add another aspect of the data to the display for the purpose of comparison.

### BRIEF DESCRIPTION OF THE DRAWINGS

FIG. 1 is a system for retrieving and displaying data according to an embodiment of the present invention.

FIG. 2 is an architecture of a tablet device according to an embodiment of the present invention.

FIG. 3 is a bar graph of enterprise data.

FIGS. 4A-4D illustrate direct manipulation of enterprise data on a screen according to an embodiment of the present invention.

FIG. 5 illustrates a display of enterprise data according to an embodiment of the present invention.

FIG. 6 is a process of displaying enterprise data according to an embodiment of the present invention.

### DETAILED DESCRIPTION

Current art requires the user to know how to activate or de-activate specific dimensions of the data. This may require specific knowledge and training of the end users on how to program and may incur additional costs for training. Further, in the context of a tablet device, the area of the touch screen included therein may be limited. Because of the limited screen area and lack of an external keyboard, it is difficult for the user to re-program the display to show other aspects of the data. Therefore, there is a need for systems and methods that allow the user to directly manipulate the data display so that the user may change the view and aspects of the displayed data.

Embodiments of the present invention may include a method for displaying enterprise data on a computing device. The method may include retrieving a data object including an enterprise data from a database, displaying at least one axis including at least one action element associated with the at least one axis on a screen, responsive to a user selection of the at least one action element, displaying a list of selectable attributes of the data, and responsive to selecting an attribute from the list of attributes, displaying a subset of the data reflecting the selected attribute.

Embodiments of the present invention may include a computing device which may include a memory and a processor configured to retrieve a data object including an enterprise data from a database, display at least one axis including at least one action element associated with the at least one axis on a screen, responsive to a user selection of the at least one action element, display a list of selectable attributes of the data, and responsive to selecting an attribute from the list of attributes, display a subset of the data reflecting the selected attribute.

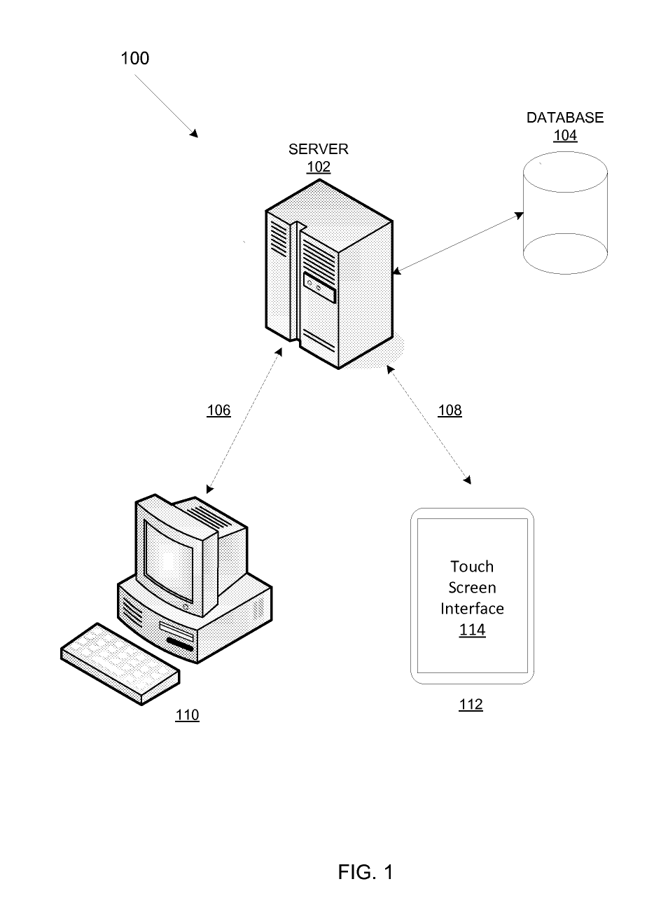

FIG. 1 is a system for retrieving and displaying data according to an embodiment of the present invention. The system 100 may include an enterprise server 102 coupled to an enterprise database 104 stored thereon enterprise data such as human resource or financial data. System 100 may further include end devices such as a desktop terminal 110 or a tablet device 112 that may be connected to the enterprise server 102 through a wired network 106 or a wireless network 108. A user may issue, on end terminal 110 or 112, a request to sever 102 via network 106 or 108 for data. The server may retrieve the requested data from database 104 and transmit the data via network 106 or 108 to end terminal 110 or 112 on which a display program may be executed to display the data to the user. The retrieved data may be stored in a local memory on the end terminal 110 or 112.

A user may use a graphic user interface to interact with the display. For example, if the end terminal is a desktop, the user may use a mouse and keyboard (not shown) to interact with the graphic display. On the other hand, if the end terminal is a tablet device, the tablet device may include a touch screen interface 114 through which the user may interact with the graphic display.

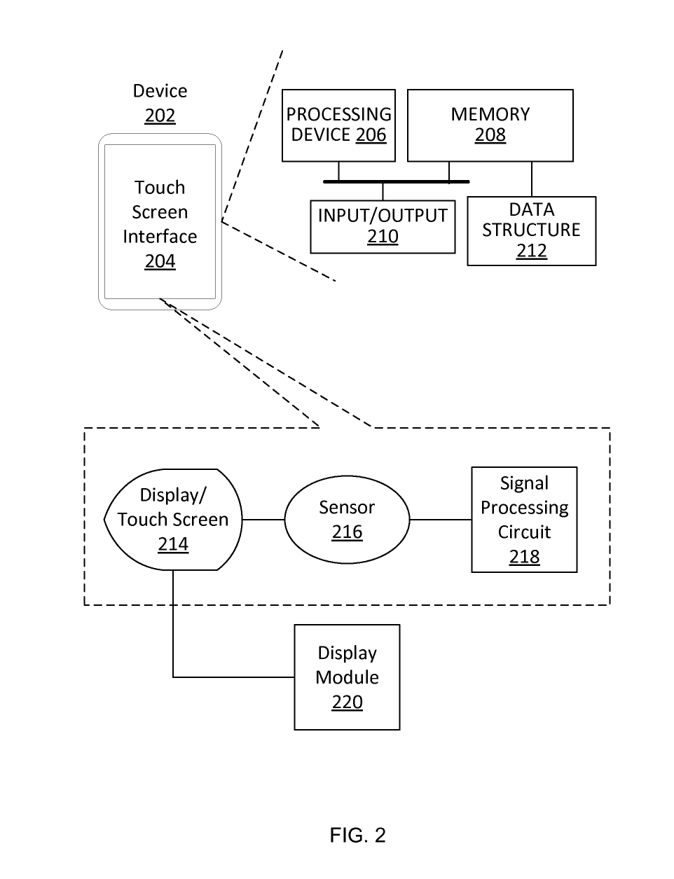

FIG. 2 is an architecture of the tablet device 202 according to an embodiment of the present invention. Device 202 may include a touch screen interface 204, display module 220, processor 206, memory 208, and communications interface (input/output) 210. The touch screen interface 204 may include a display 214, which may be a touch screen, capable of displaying data to a user of the device 202. The display 214 may be coupled to the display module 220 and a sensor 216, which may be a capacitive touch detection sensor, configured to detect and track movement on the surface and/or in the vicinity of the display 214. The sensor 216 may be coupled to a signal processing circuit 218 that may be configured to identify, locate, and/or track object movement based on the data obtained from sensor 216.

Memory 208 may include a computer readable medium storing application modules, which may include instructions associated with the display module 214. Additionally, the memory may store data received from communication interface 210. The display module 220 may also be coupled to and/or include the processor 206, which may be used to execute instructions causing the touch screen interface 204 to display particular data. In some instances, the display module 220 may be a display module capable of displaying a filter menu including a first list of selectable characteristics for filtering data in the touch screen interface 204. The display module 220 may also be capable of, responsive to a user selection of one of the selectable characteristics in the first list from the touch screen interface, displaying a second list of selectable values associated with the selected first list characteristic in the filter menu of the touch screen interface. The display module 220 may also be capable of repeating the displaying of the second list of selectable values when a new user selection of one of the selectable characteristics in the first list is made. The display module 220 may also be capable of displaying filtered data and a plurality of selectable objects in the touch screen interface, each of the plurality of selectable objects corresponding to a different selected first list characteristic having at least one stored user selected value associated with it. The display module 220 may also be capable of displaying an interface for a user to select a different value from the second list associated with its respective first list characteristic for re-filtering responsive to a user selection of the one of the selectable objects.

Communications interface 210 may enable connectivity between the processing devices 206 in the device 202 and other systems by encoding data to be sent from the processor 206 to another system over a network and decoding data received from another system over the network for the processor 206.

In an embodiment, memory 208 may a computer readable media for retrieving, presenting, changing, and saving data. Memory 208 may include a variety of memory devices, for example, Dynamic Random Access Memory (DRAM), Static RAM (SRAM), flash memory, cache memory, and other memory devices. Additionally, for example, memory 208 and processing device(s) 206 may be distributed across several different computers that collectively comprise a system. Memory 208 may be capable of storing each user selected value from the displayed second list each time the second list is displayed

Processor 206 may perform computation and control functions of a system and comprises a suitable central processing unit (CPU). Processor 206 may include a single integrated circuit, such as a microprocessing device, or may include any suitable number of integrated circuit devices and/or circuit boards working in cooperation to accomplish the functions of a processing device. Processor 206 may execute computer programs, such as object-oriented computer programs, within memory 208. Processor 206 may be capable of filtering data according to each stored user selected value associated with each respective selected first list characteristic.

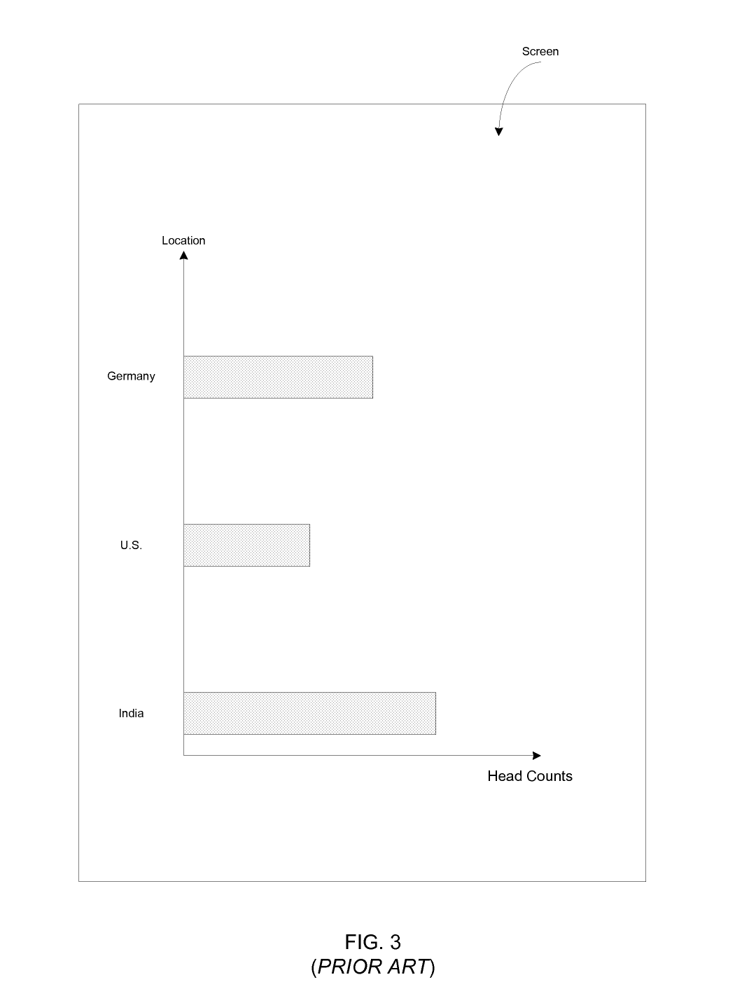

An end terminal may retrieve data from an enterprise database and extract a subset of the data to display. Current art may display the subset of data as static display. FIG. 3 shows an example static display of a human resource data. As shown in FIG. 3, the display includes a bar graph which has an x-axis indicating head counts (or, numbers of employees) and an y-axis indicating geographic locations. In this example, the display shows three bars indicating the head counts of the enterprise in Germany, U.S., and India. However, the display of FIG. 3 is static in the sense that if the user wants to change to see a second subset of data, the user cannot directly access the second subset of data from the display. Instead, the user may need to switch to another screen to retrieve the second subset of data and execute a display command to display the second subset of data. This is inconvenient to the user, especially for tablet devices such as tablet computers or smart phones which have limited display screen.

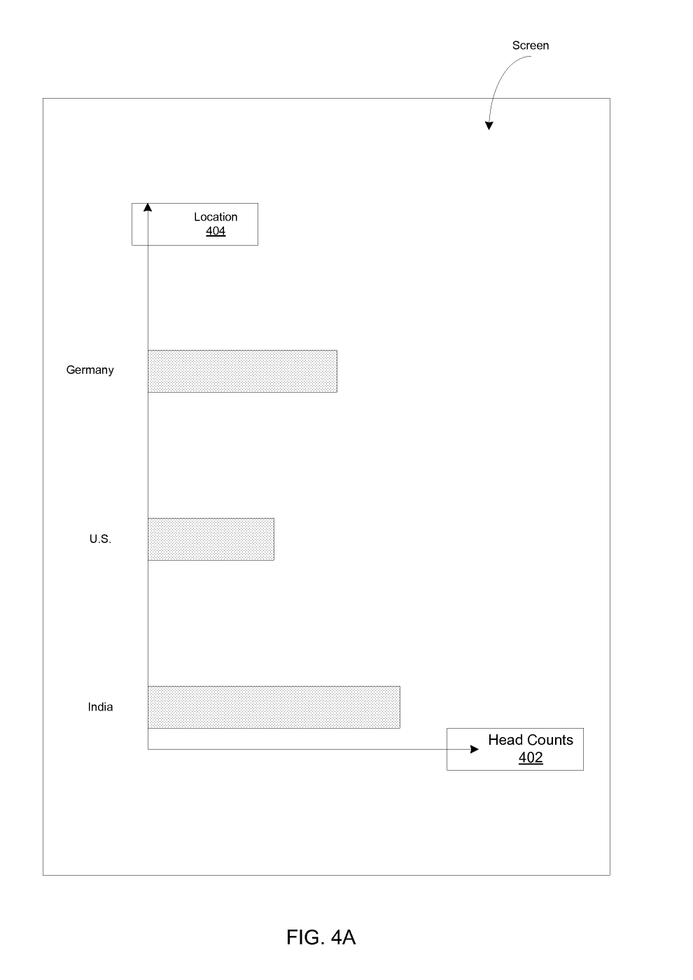

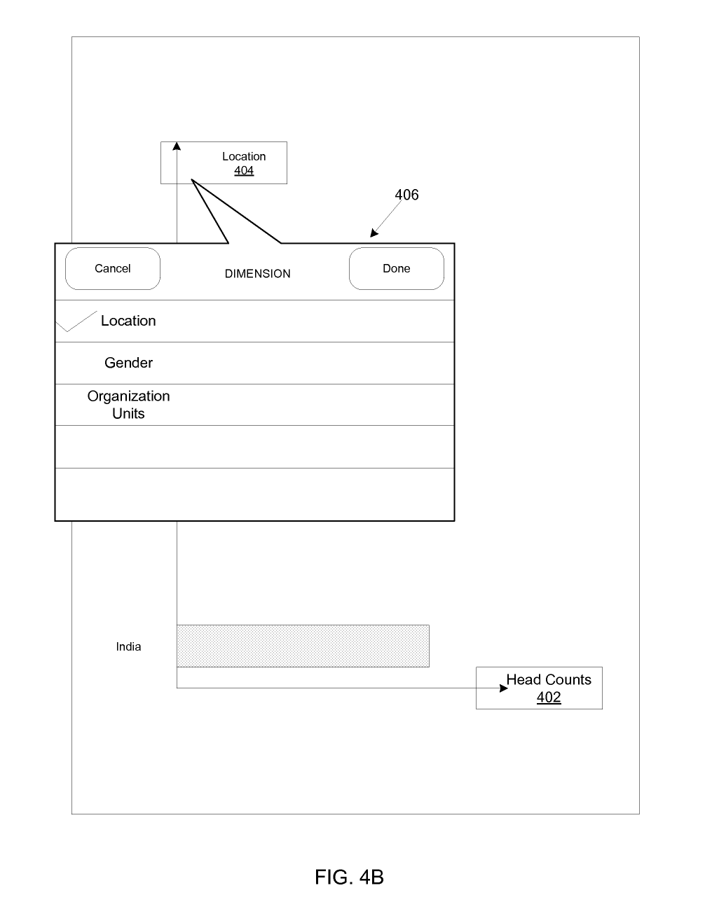

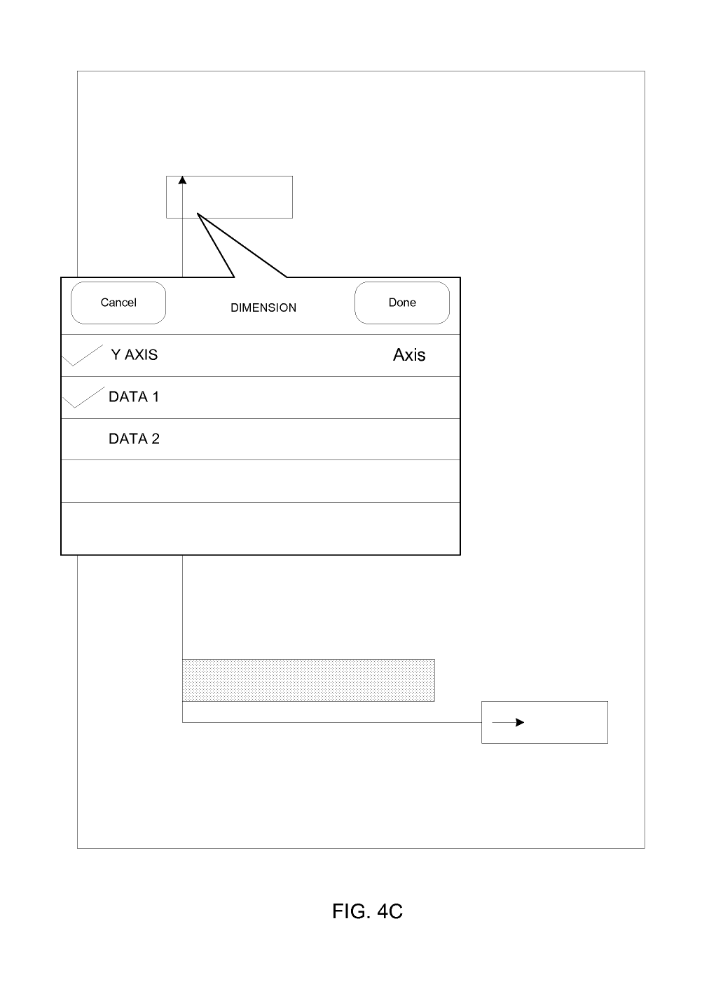

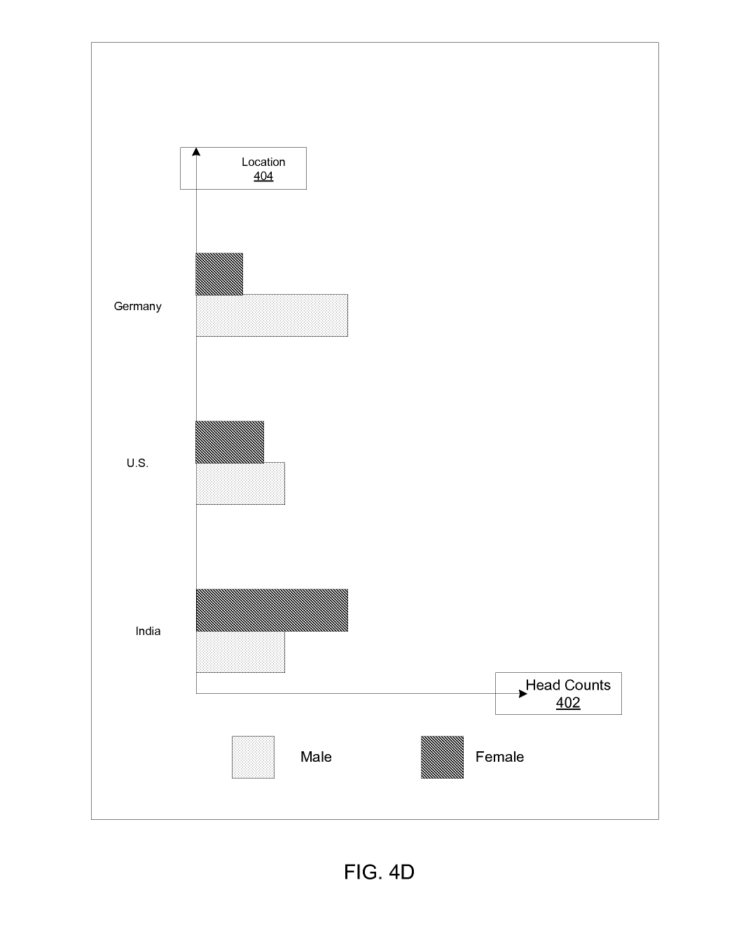

Embodiments of the present invention may display enterprise data along with action elements that allow a user to directly switch display of different subsets of the enterprise data. Because of the direct switches between different displays, the change of displays is intuitive to the end user. When a user activates an action element, the processing unit may be configured to execute a display program to display a list of attributes of the enterprise data for the user to select. In response to the selection of a specific attribute (or dimension) of the enterprise data, the display program may display the selected dimension of the enterprise data. FIGS. 4A-4D illustrate displays of enterprise data according to an embodiment of the present invention. For the convenience of discussion, FIGS. 4A-4D use human resource data as an illustrative, non-limiting example.

FIG. 4A is a display of enterprise data according to an embodiment of the present invention. The enterprise data may include a multi-dimensional data, each dimension specifying an attribute of the enterprise data. The exemplary human resource data may include head counts, geographic locations, and gender. As shown in FIG. 4A, a processing unit (such as a CPU or GPU) may be configured to execute a display program that displays a bar graph of the head counts (x-axis) of the enterprise data in terms of geographic locations (y-axis) of the enterprise data. Further, embodiments of the present invention may associate action elements with each axis. The action elements may be suitable graphical icons including a push button and a dropdown box. In one embodiment as shown in FIG. 4A, a first button 402 may be displayed in association with the x-axis and a second button 404 may be displayed in association with the y-axis. Buttons 402, 404 may be displayed as part of the x and y-axes. Buttons 402, 404 may be activated by the user. When the display is a touch screen of a tablet device, buttons 402, 404 may be activated by tapping or placing a finger near the button. When the display is not a touch screen, buttons 402, 404 may be activated by clicking a mouse over them or moving a cursor near them. In other embodiments, action elements other than buttons may be associated with the axes. In an alternative embodiment, the axes themselves may be action elements. Thus, a user may tap or click a mouse on a portion of the x-axis or y-axis directly to activate the respective axis. While buttons 402, 404 are displayed at the tip of the axes, embodiments of the present invention are not limited to the specific placement of the action elements. The action elements may be placed at a suitable location on the axes.

If the user activates an action element, the display program may expose a list of dimensions of the enterprise data that may be additionally added to the graphic display. FIG. 4B shows the results of user activating button 404. In response to the activation, a popup dropdown box 406 may be displayed to expose a list of dimensions of the enterprise data that may be selected. In one embodiment, the box 406 may include a first push button (“Cancel”), a second push button (“Done”), and a list of items (“Gender,” “Organization Units”) to the “Location” dimension of the human resource data. The user may select one or more items from the list to be displayed in the bar graph. For example, as shown in FIG. 4C, the user may select “Gender” (which is indicated by a check next to “Gender”) to show in the bar graph. After the selection, the user may tap or click the “Done” button to cause a refresh of the display for displaying the gender. If the user does not make a change to the displayed bar graph, the user may tap or click the “Cancel” button to cancel the popup box 406.

In response to the user selection of the item of “Gender,” the display program may display the head counts of geographic locations in terms of a split between male and female employees. As shown in FIG. 4D, in one embodiment, two bars may be displayed at each geographic location. A first bar (of lighter shade) may represent a head counts of male employees at that location, and a second bar (of darker shade) may represent a head counts of female employees at that location. In this way, the user may select which subset of the human resource data to display. Similarly, the user may activate the second button to display a list of dimensions associated with head counts. For example, the list may include “high potential head counts” or “alumini head counts.” The user may select one of the listed dimension to display the bar graph in terms of the selected aspect associated with the head counts. For example, the bar graph may display “high potential head counts” at each location or display male/female “high potential head counts” at each location.

In one embodiment, the dimensions or attributes associated with the x-axis or y-axis may be predetermined in the sense that each action elements 402, 404 may be associated with a predetermined number of subsets of enterprise data. Thus, when the user activates an action element, the displayed list may include all of the predetermined dimensions or attributes.

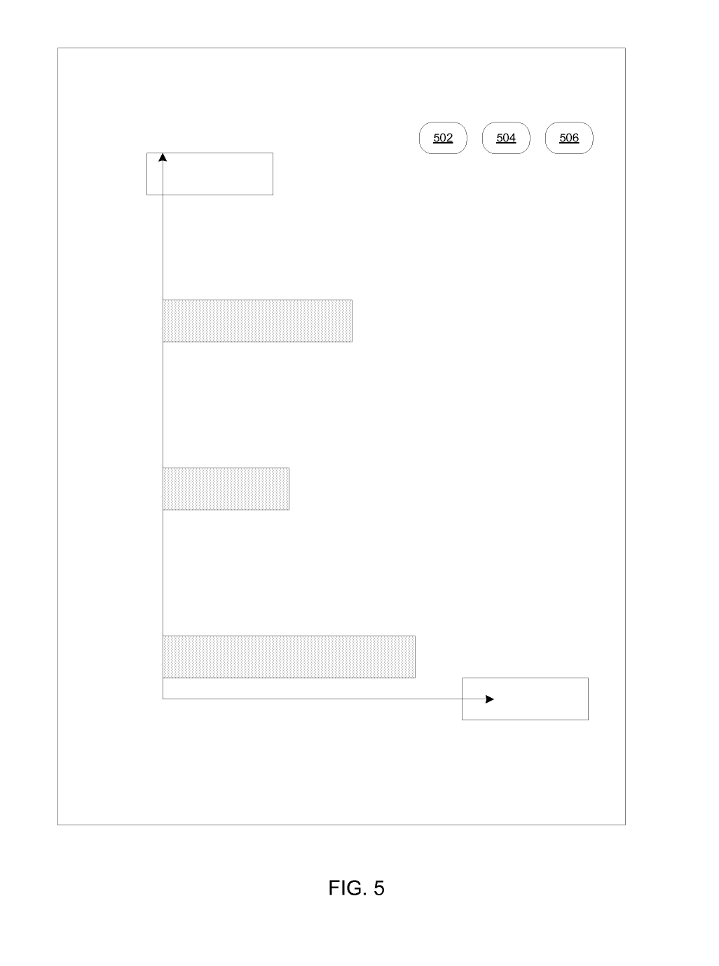

Further, the display program may display other types of icons on the screen to facilitate change of views. In one embodiment, as shown in FIG. 5, a toggle button 502 may be displayed on the screen. A selection/de-selection of the toggle button 408 may switch the displayed view from a bar graph to a pie graph or vice versa. Additionally, a push button 504 may be displayed. When a user activates push button 504, a dialog box including filters may be displayed. The user may use the filter to limit the display to certain range of values. For example, the user may limit the display to head counts above a minimum number and below a maximum number. Alternatively, the user may limit the display to a certain time period such as for the last ten years. The display program may also display a button 506 for saving the displayed graph as an image file.

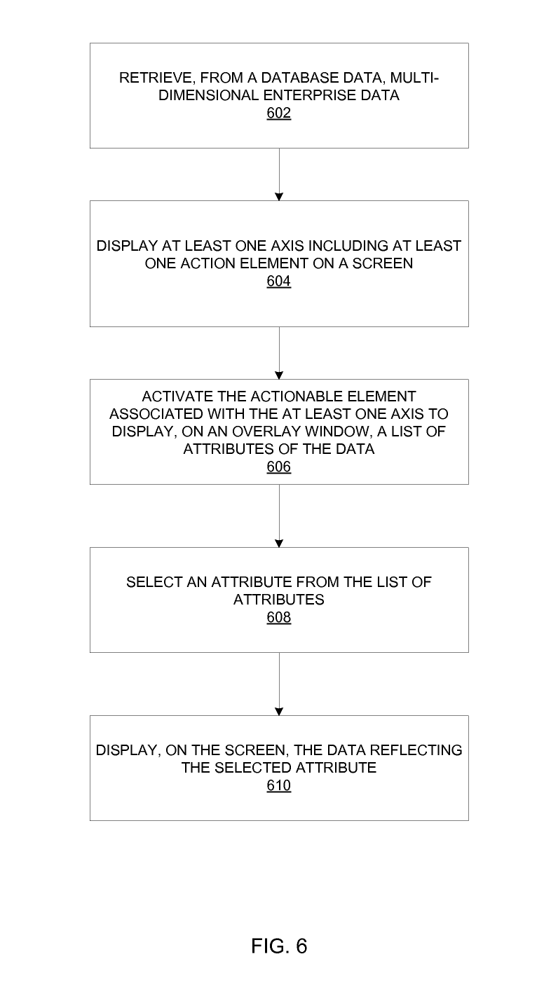

FIG. 6 is a process of displaying enterprise data according to an embodiment of the present invention. At 602, a processing unit (such as an CPU or GPU) of an end terminal may be configured to retrieve, from an enterprise database, a multi-dimensional data such as human resource data or financial data. Each dimension of the data may represent an attribute of the enterprise data. For example, the attributes may be head counts, geographic locations, or gender. The retrieved data may be stored in a local memory of the end terminal. Alternatively, the retrieved data may be stored on an enterprise server that is connected to the end terminal and may be retrieved on demand. In one embodiment, the server may be in a computing cloud so that the end terminal may fetch the enterprise data as needed. At 604, the processing unit may execute a display program to display one or more axes, each axis including, as part of the axis, at least one action element. In one embodiment, a portion of the retrieved data may be displayed on a screen along with the at least one axis including the at least action element. Further, each of the at least axis may be associated with at least one action element. For example, the display program may display a push button at the tip of each axis.

At 606, in response to a user selection of the action element (such as tapping or clicking on the push button), the processing unit may be configured to activate the action element associated with the at least axis. In response to the activation, the display program may display a list of attributes of the enterprise data for the user to select which attribute to display. In one embodiment, the list of attributes may be displayed as an overlay over the already displayed data graph. At 608, the processing unit may receive a user selection from the list of which dimension to be displayed on the screen. In one embodiment, the user may select one or more items from the list. In response to the user selection of the one or more items from the list, the display program may retrieve a subset of data that matches the selected attribute and at 610, display subset of data on the screen. In this way, the user may conveniently switch displays of different attributes (dimensions) of the enterprise data.

Although the present invention has been described with reference to particular examples and embodiments, it is understood that the present invention is not limited to those examples and embodiments. Further, those embodiments may be used in various combinations with and without each other. The present invention as claimed therefore includes variations from the specific examples and embodiments described herein, as will be apparent to one of skill in the art.

We claim:

1. A method for displaying data on a computing device, comprising:
retrieving, by a processor, a data object including an enterprise data from a database;
displaying, by the processor, at least one axis including at least one action element associated with the at least one axis on a screen;
responsive to a user selection of the at least one action element, displaying, by the processor, a list of selectable attributes of the data; and
responsive to selecting an attribute from the list of attributes, displaying, by the processor, a subset of the data reflecting the selected attribute.

2. The method of claim 1, wherein the tablet device in one of a tablet computer and smart phone.

3. The method of claim 2, wherein the tablet device includes a touch screen.

4. The method of claim 3, wherein the action element is a push button displayed on the at least one axis on the touch screen and wherein the action element is activated by a user tapping the push button.

5. The method of claim 3, wherein the displayed at least one axis is the action element, and wherein the action element is activated by a user tapping on the at least one axis.

6. The method of claim 1, wherein the processor is configured to display two axes each including an action element on the screen.

7. The method of claim 1, wherein the list of selectable attributes is displayed in a dropdown box.

8. The method of claim 1, wherein the subset of data is displayed as one of a bar graph and a pie graph.

9. The method of claim 1, wherein the enterprise data is stored in a cloud, and the tablet device is a mobile device.

10. A computing device, comprising:
a memory, and
a processor, configured to:
retrieve a data object including an enterprise data from a database;
display at least one axis including at least one action element associated with the at least one axis on a screen;
responsive to a user selection of the at least one action element, display a list of selectable attributes of the data; and
responsive to selecting an attribute from the list of attributes, display a subset of the data reflecting the selected attribute.

11. The computing device of claim 10, wherein the retrieved data is stored in the memory.

12. The computing device of claim 10, wherein the computing device in one of a tablet computer and smart phone.

13. The computing device of claim 12, wherein the tablet device includes a touch screen.

14. The computing device of claim 13, wherein the action element is a push button displayed on the at least one axis on the touch screen and wherein the action element is activated by a user tapping the push button.

15. The computing device of claim 13, wherein the displayed at least one axis is the action element, and wherein the action element is activated by a user tapping on the at least one axis.

16. The computing device of claim 10, wherein the processor is configured to display two axes each including an action element on the screen.

17. The computing device of claim 10, wherein the list of selectable attributes is displayed in a dropdown box.

18. The computing device of claim 10, wherein the subset of data is displayed as one of a bar graph and a pie graph.

19. The computing device of claim 10, wherein the enterprise data is stored in a cloud, and the computing device is a mobile device.

20. A non-transitory computer readable medium having stored thereon executable instructions that when executed by a processing device on a device having a screen interface, cause the processing device to:
retrieve a data object including an enterprise data from a database;
display at least one axis including at least one action element associated with the at least one axis on a screen;
responsive to a user selection of the at least one action element, display a list of selectable attributes of the data; and
responsive to selecting an attribute from the list of attributes, display a subset of the data reflecting the selected attribute.
